(19) United States
(12) Patent Application Publication
(10) Pub. No.: US 2026/0367710 A1
(43) Pub. Date: Nov. 19, 2026

(54) Smart Wearable Band

(71) Applicant: Randall Alley, Thousand Oaks, CA (US)

(72) Inventor: Randall Alley, Thousand Oaks, CA (US)

(21) Appl. No.: 19/207,281

(22) Filed: May 13, 2025

(51) Int. Cl. G06F 3/01; G06F 1/16

(52) U.S. Cl. CPC G06F 3/017; G06F 1/163

(57) ABSTRACT

A smart wearable band is described. The band has a first loop that fits around the user's thumb and a second loop that fits around the user's wrist. The first and second loops are joined together at an intersection disposed over the thenar webspace on the dorsal side of the hand. The band also has a smart device mounted on the outward-facing surface of the band and over the thenar webspace of the hand. One or more sensors are mounted on, embedded in, or placed on, an inward-facing surface of the second loop over the wrist on the palmar side. The sensor is positioned directly in contact with, or in proximity to, a radial artery to track the user's health and other physiological parameters. The band also has one or more sensors for detecting hand, wrist, and finger gestures and/or motions to control the smart device and/or a remote device.

### FIELD OF THE INVENTION

The field of the invention is wearables, more specifically, wearable bands for monitoring physiological parameters and for detecting hand gestures.

### BACKGROUND

The following description includes information that may be useful in understanding the present invention. It is not an admission that any of the information provided herein is prior art or relevant to the presently claimed invention, or that any publication specifically or implicitly referenced is prior art. All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Smart watches and fitness trackers have gained popularity with the rise of smart devices and are a convenient way to not only tell time but track physiological parameters. Traditional watch designs place the display on the dorsal side of the wrist, which requires raising the hand and twisting or rotating the wrist or forearm to view the display. Alternative watch designs place the display near the side of the thumb or thenar webspace, eliminating the need to rotate the forearm. See, for example, US2926825, USD809953, and https://ergonband.com/. While advantageous in some respects, these designs are bulky, uncomfortable, and lack the ability to detect hand gestures for controlling the smart device or a remote device.

Others have sought to provide wearable devices that detect hand gestures for controlling remote devices. https://gest.co/, for example, provides a wearable device that has nine-axis motion sensors, four snap-on finger mounts, and a hand strap that allows the user to control a computer with hand gestures. However, the device is bulky and is not well-suited for physical activities such as running, exercising, or sports. The device also does not have a clock, display, or sensors for monitoring physiological parameters. What is needed is a smart wearable device with health monitoring capabilities that can be comfortably worn during activity and easily viewed without rotating the forearm. What is also needed is a sleek, low-profile smart wearable device that detects hand gestures and can be comfortably worn during physical activity.

Thus, there is still a need for improved smart wearable hand devices.

### SUMMARY OF THE INVENTION

The inventive subject matter provides apparatus, systems and methods for a smart wearable band to be worn on a user's hand. The band comprises a first loop sized and dimensioned to fit snugly around a base of a thumb of the hand, and a second loop sized and dimensioned to fit around a wrist of the hand. The first loop and second loop are joined at an intersection that is disposed over or near a metacarpal bone of the thumb on the dorsal side of the hand. A smart device is mounted on, placed on, or embedded in, an outward facing surface of the intersection between the first loop and the second loop. One or more sensors is also mounted on, placed on, or embedded in, an inward-facing surface of the second loop over a wrist of the hand on the palmar side for measuring and monitoring physiological parameters such as heart rate, pulse, body temperature, blood oxygen, sleep time/cycle, calorie's burned, respiration, EKG, stress, fall detection, and women's health. The smart device and sensor(s) are preferably flush with the outward-facing or inward-facing surface of the band. The sensor is preferably positioned directly in contact with a radial artery pulse point on the palmar side of the wrist. The band can optionally include additional sensors for detecting hand gestures. It is further contemplated that one or more sensors, wires, controllers, flexible printed circuits, and other electrical components can be embedded and hidden within the band or placed throughout any location on the band. It is also contemplated that the smart wearable band has no sensors.

The band is preferably made of silicone, rubber, elastomeric polymer, or other material that allows the first loop and second loop to stretch and widen. In some embodiments, the band is one unitary part, and first and second loops may be formed together in the same manufacturing step or process. The manufacturing process can include the step of embedding sensors, smart device, and any other components, in the band during formation of the loops. For example, components can be placed into a mold during injection molding, or into a 3D printer during printing, with flexible printed circuits laminated between layers of elastomeric material. The components can either be embedded flush with the surface of the band, or embedded and hidden within the band. It is also contemplated that the smart device and sensors can be removable from the band and are added to the band after the loops are formed. For example, the smart device and sensors can be press-fit or snap-fit into recessions, compartments, housings in the band with watertight seals. It is also contemplated that the first loop and second loop can be removably coupled together.

In other aspects of some embodiments, the exterior surface of the band can be one continuous surface. The exterior surface of the band is preferably smooth, especially the surfaces that contact the user's hand. However, textured or non-smooth surfaces are also contemplated. The exterior surface is also preferably soft and comfortable to wear directly against the skin.

The first loop and the second loop each have a thickness, height, length, and elasticity. The thickness can be constant throughout the band or may vary depending on the user's preferences for fit and comfort. The first band and the second band can form an X shape at the intersection. The first loop is configured to anchor the band around the thumb and enable thumb gesture detection. The intersection is disposed in a thenar webspace between the thumb and index finger to stabilize the smart device during hand movements. The band is preferably configured to ensure that the intersection in the thenar webspace remains stable during thumb abduction and adduction. The second loop is configured to fit snugly around the user's wrist but is sufficiently stretchable to don on and off by placing the hand through the second loop. The smart device preferably includes a display located at the thenar webspace to enable viewing without wrist rotation.

In some embodiments, a wired connection is embedded in the band and electrically couples one or more sensors to the smart device. The smart device can be removably embedded in or mounted on the outward-facing surface of the intersection. One or more sensors can also be removably embedded in or mounted on the inward-facing surface of the second loop in contact with the user's skin. Additional sensors can also be mounted or embedded anywhere throughout the band. The second loop can be configured to apply a contact pressure between 10 and 30 mmHg to ensure reliable sensor readings without causing discomfort.

In yet other aspects of some embodiments, one or more sensors are configured to detect omni-directional movement of at least one of a wrist, a thumb, and an index finger. As used herein, omin-directional movement means movement in three-dimensional space including linear translation and rotation about x, y, z axes. In such embodiments, a programmable microprocessor or controller can be used to control the smart device in the band, or a remote device, based on a movement or gesture of the hand, wrist, or finger and based on sensor data.

The smart devices includes a display. The display can be used to show information that is typical of a smart watch or smart phone, including time, sensor data (e.g., physiological parameters), text communications, etc. The sensor data is preferably displayed in real-time to monitor health during exercise, sports, and other physical activities or events. The controller can be programmed to provide notifications to the user or to another remote device. The smart device can also include one or more wireless transceivers for sending and receiving communications with remote devices or electrical components embedded within the band.

Various objects, features, aspects and advantages of the inventive subject matter will become more apparent from the following detailed description of preferred embodiments, along with the accompanying drawing figures in which numerals represent like components.

### BRIEF DESCRIPTION OF THE DRAWINGS

FIG. 1 is a top, right side perspective view of a smart wearable band.

FIG. 2 is front elevation view of the smart wearable band of FIG. 1.

FIG. 3 is a left-side view of the smart wearable band of FIG. 1.

FIG. 4 is a right-side elevation view of the smart wearable band of FIG. 1.

FIG. 5 is a rear elevation view of the smart wearable band of FIG. 1.

FIG. 6 is a top elevation view of the smart wearable band of FIG. 1.

FIG. 7 is a bottom plan view of the smart wearable band of FIG. 1.

FIG. 8 is a top elevation view of the smart wearable band of FIG. 1 on a user's hand.

FIG. 9 show various hand gestures for controlling the smart wearable device of FIG. 1 or for controlling a remote device.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

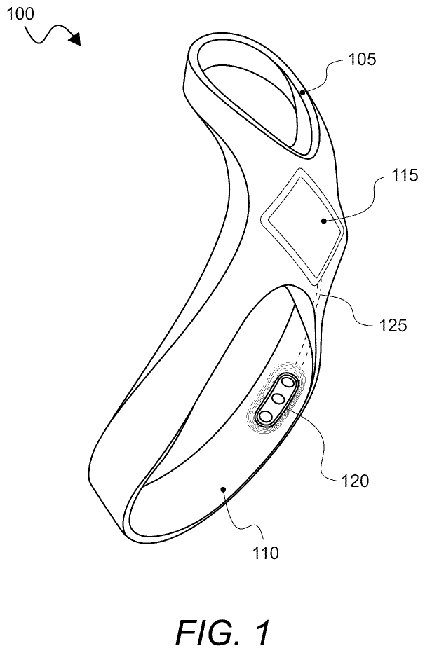

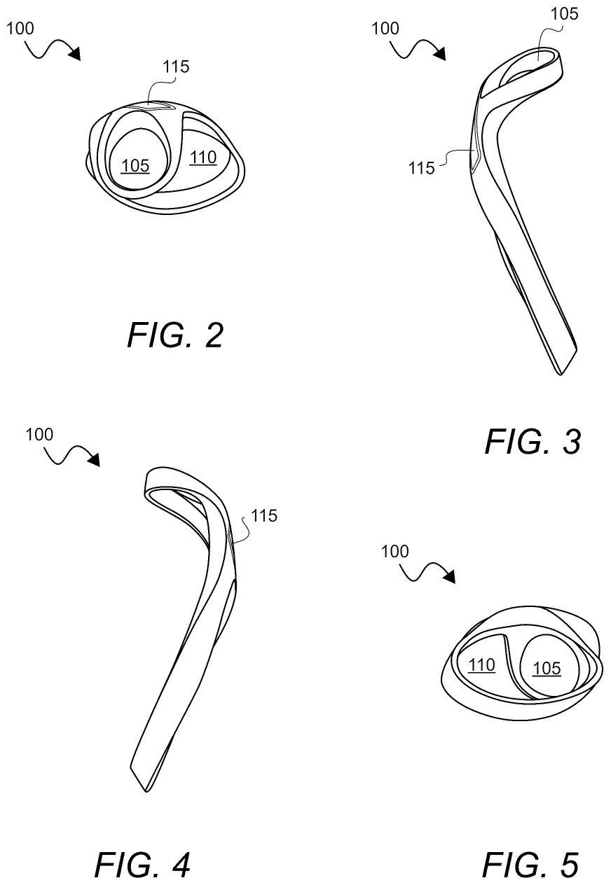

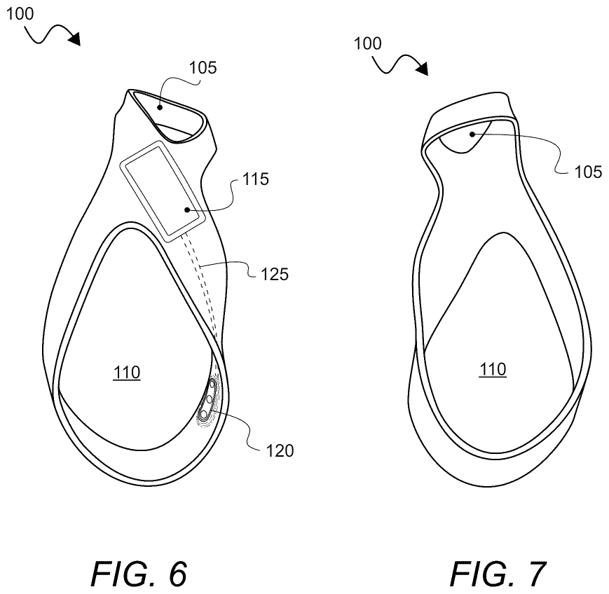

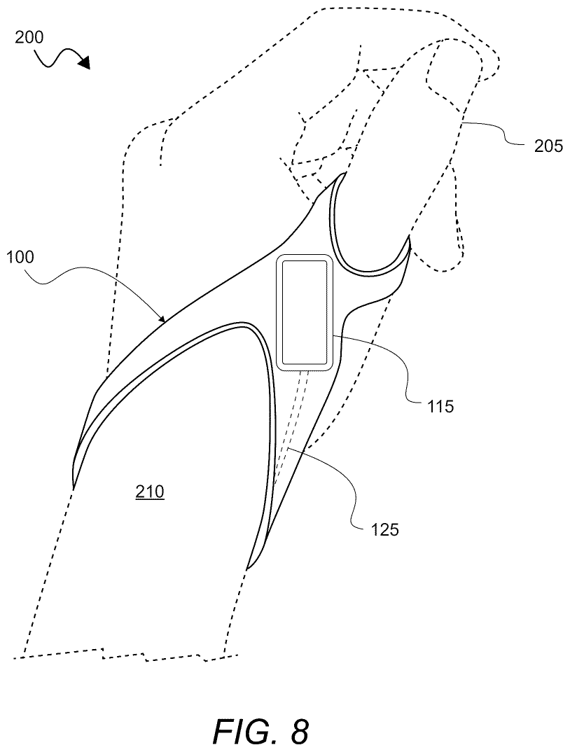

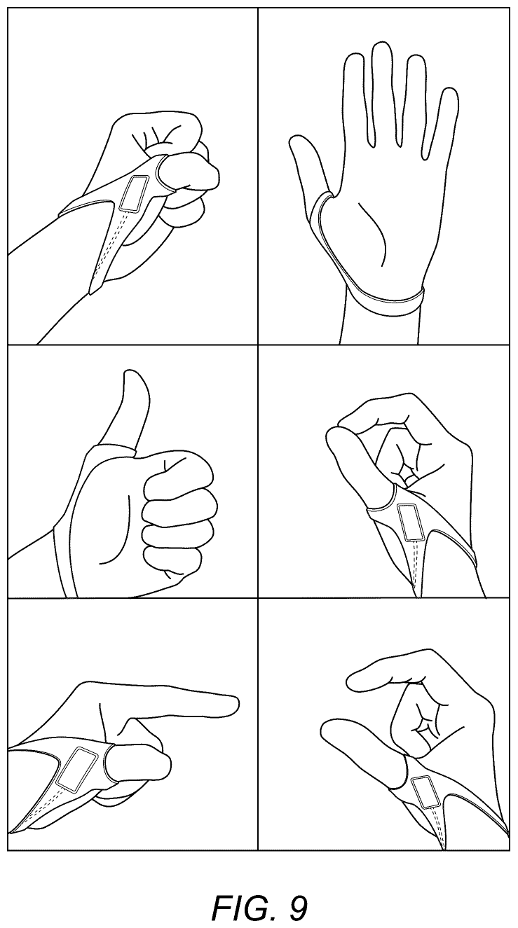

FIG. 1 shows a perspective view of a smart wearable band 100. FIGS. 2-7 show front, left-side, right-side, rear, top, and bottom views of band 100. FIG. 8 shows a perspective view of band 100 on a user's hand 200. Band 100 has a first loop 105 and a second loop 110. First loop 105 is sized and dimensioned to fit snugly around a base of thumb 205 of the hand 200. Second loop 110 is sized and dimensioned to fit around a wrist 210 of hand 200. First loop 105 and second loop 110 are joined at an intersection that is near a metacarpal bone of thumb 205 and over the thenar webspace on the dorsal side of hand 200. A smart device 115 is positioned on an exterior outward-facing surface of the intersection between first loop 105 and second loop 110.

One or more sensors 120 is/are embedded flush on an inward-facing surface of second loop 110 over wrist 210 of hand 200 on the palmar side. Sensor 120 can be positioned to directly contact, or be in close proximity to, a radial artery pulse point on the palmar side of wrist 210 to monitor the user's pulse rate. Band 100 can also include one or more sensors for monitoring the user's heart rate, blood oxygen level, or any other physiological parameter. Contemplated sensors include optical sensors, strain gauges, motion sensors, accelerometers, environmental sensors, infrared sensors, pressure sensors, light sensors, ultrasonic sensors, flow and level sensors, audio sensors, touch sensors, humidity sensors, magnetic sensors, position or tilt sensors, PIR sensors, gyroscope sensors, capacitive sensors, piezoelectric sensors, thermal sensors, temperature sensors, RFID sensors, chemical sensors, and gas sensors. The additional sensors can be placed anywhere on or within band 100, including first loop 105, second loop 110, and the intersection between first loop 105 and second loop 110. The sensors and smart device 115 are preferably embedded within band 110 or mounted flush on the exterior surfaces of band 100 so that band 100 maintains a low-profile and has a continuous, smooth, exterior surface.

Band 100 can be made of silicone, rubber, elastomeric polymer, or any other material that allows first loop 105 and second loop 110 to stretch and widen so that the loops can be easily donned and doffed of thumb 205 and wrist 210. Band 100 can also be made of a property-changing or phase-changing material, such as a thermoplastic elastomer, hydrogel, or rheologic material, so that the band is softer and/or stretchable while donning and doffing but harder and more rigid while wearing. Band 100 is one unitary part, and it is contemplated that they are formed in the same manufacturing step (e.g., injection molding, 3D printing). However, it is also contemplated that, in an alternative embodiment, first loop 105 and second loop 110 are manufactured separately and/or are removably coupled together. In such embodiments, band 100 can be donned by placing first loop 105 on thumb 205, placing second loop 110 on wrist 210, and attaching first loop 105 with second loop 110 to form the intersection, not necessarily in that order. The intersection is shown in the figures to have an X-shape; however, other shapes can be used without departing from the inventive features. The shape of the intersection is preferably designed to provide comfort, stretchability, and simplicity.

First loop 105 and second loop 110 each have a thickness, height, length, and elasticity. The dimensions and material properties of first loop 105 and second loop 110 are designed to be light weight with a low-profile so that band 100 can be worn during activity without nuisance. The dimensions and modulus of elasticity can be chosen to exert a pressure of 10-30 mmHg around thumb 205 and/or wrist 210 to provide a snug yet comfortable fit. First loop 105 and second loop 110 are sufficiently stretchable such that they can be easily donned and doffed of thumb 205 and wrist 210. The dimensions and materials can be customized based on a measurement of the user's band. The hand can be measured by scanning and the scan can be uploaded to CAD software to design a custom band 100. The hand can also be measured by taking a mold of the hand. The dimensions and materials of band 100 can also be selected by using a sizing chart.

Band 100 has one or more wired connections 125 embedded therein that electrically couples the sensor(s) 120 to smart device 115. However, it is also possible that smart device 115 could communicate with sensor(s) 120 via a wireless connection. In some embodiments, smart device 115 is removable from band 100 and can be interchanged with different smart devices. In this embodiment, band 100 can be sold as an accessory. Smart device 115 is mounted on and/or embedded in, the surface of the intersection and is facing outward (i.e., away from the user's skin). Smart device 115 is preferably flush with the surface of band 100. Smart device 115 is conveniently located on or near the thenar webspace of hand 200 so that the user can view smart device 115 without rotating wrist 210 or the forearm. Smart device 115 preferably has a display for showing information such as a clock, the weather, physical activity data, health data, and any other information typically shown on a smart watch or fitness tracker.

Sensor(s) 120 can either be permanently or removably mounted on or embedded in band 100. Sensors(s) 120 are preferably flush with the surface of band 100 to maintain a low profile. Sensor(s) 120 are shown in the figures as being located on the inward-facing surface of second loop 110 (i.e., facing the skin). This placement allows sensor(s) 120 to sense pulse from the radial artery. However, additional sensors can be located anywhere on, within, or throughout band 100 based on the desired sensory data. Some sensors are preferably configured and programmed to sense the motion and/or position of hand 200, thumb 205, wrist 210, and the index finger. Such sensors may be configured to directly sense motion (e.g., accelerometers) or indirectly sense motion (e.g., strain gauges that sense stretching of the band). The sensors are preferably configured to detect omni-directional movement of thumb 205, the index finger, wrist 210, and/or hand 200. Band 100 can also include flexible printed circuits and other electrical components embedded therein to provide the functionality of smart device 100.

FIG. 9 shows six examples of different hand gestures or movements that band 100 can be programmed to detect. Smart device 110 preferably includes a microprocessor or controller programmed to detect the gestures and movements to control functionality of smart device 100 and/or a remote device such as a smart phone, computer, television, appliance, medical equipment, household smart system, or vehicle,

Band 100 provides numerous technical advantages, such as a low-profile and lightweight fitness tracker that can be comfortably worn during physical activity. The flush mounted sensors and stretchability/elasticity of the loops ensure reliable sensor readings of the radial artery and/or skin by providing an appropriate amount of pressure (e.g., between 10 and 30 mmHg). Sensory data can be displayed in real-time and recorded to smart device 115 and transmitted to a remote device for storage, analysis, and/or monitoring. Smart device 115 is located on the thenar webspace to facilitate viewing and also to stabilize smart device 115 during hand gestures. Band 100 and smart device 115 can also be constructed with a waterproof design and/or materials so that it can be worn during swimming and other water sports. Smart device 115 can also be designed for use in zero gravity environments. In this manner, an improved durable smart wearable is provided for use in extreme environments and harsh conditions.

Band 100 can have a rechargeable and/or removable battery and a docking station. It is contemplated that the battery can be charged using a wired or wireless connection, Band 100 can also include a solar panel for recharging or a kinetic energy charging system.

In a first use case, an athlete engaged in running, cycling, and swimming can use the smart wearable band to monitor real-time physiological parameters like heart rate, blood oxygen, and pulse via sensors contacting the radial artery. The waterproof, low-profile design ensures comfort during intense physical activities, and the thenar webspace display allows easy viewing without wrist rotation. A marathon runner can use the band to track heart rate zones and receive alerts if their pulse exceeds a safe threshold, with data displayed instantly on the band's screen. The athlete can also use the smart wearable band to track his/her location using GPS data, and can use hand gestures to send communications (e.g., text messages) without taking a break and without needing to touch a screen.

In a second use case, doctors, surgeons, lab researchers, chefs, and other professionals working in a sterile environment can use the smart wearable band to control equipment, appliances, and intelligent devices in a hands-free manner to prevent cross-contamination. Gestures like thumb flexion or wrist rotation can scroll through menus and selection options. Hand motions such as swiping or poking can be used to read or send text messages, initiate phone calls, or record voice memos without any physical contact. In this manner, the professional can maintain a sterile environment while accessing critical data and operating smart devices,

In a third use case, individuals with physical disabilities can operate devices with minimal body movement and strength. A partially paralyzed person use the smart wearable band to control a wheel chair, computer, smart home system (turning on lights or adjusting the thermostat) with minimal hand movements and simple thumb or finger gestures. A hearing impaired or speech impaired person can use the smart wearable band to produce audible speech or visual text using hand gestures and sign language. The smart wearable band can even be trained to translate American Sign Language (ASL) gestures into text or speech in order to communicate with those who do not know ASL. The smart wearable band can detect falls, injuries, or impairments, and can be used to communicate with emergency services. The lightweight, stretchable design ensures comfort for prolonged wear,

In a fourth use case, the smart wearable band is used for gaming and virtual reality (VR) interactions. Gamers can use the band to enhance immersive experiences in VR or augmented reality (AR) games by mapping hand gestures to in-game actions. The band's sensors detect three-dimensional movements (e.g., wrist rotation, finger taps), offering precise control without bulky controllers. A VR gamer can wear the band to perform actions like casting spells or aiming weapons in a fantasy game, using natural hand gestures detected by the band,

In a fifth use case, the smart wearable band is used to improve workplace productivity and task management. Office workers or field technicians can use the band to monitor stress levels (via heart rate variability) and manage tasks through gesture-based interactions with productivity apps. The display shows notifications or reminders, and gestures allow quick responses without needing to access a phone or computer. A project manager can wear the band to receive and announce calendar alerts, either visually or audibly, and uses a wrist flick to mark tasks as complete in a connected app, while monitoring stress during high-pressure meetings. The low-profile ergonomic design allows the band to blend in the user's workflow. The band can also be skin-colored so that it is less noticeable during meetings and less of a distraction when not being used. Alternatively, the band could be glow-in-the dark or reflective so it can be seen in lower lighting or from afar.

In a sixth use case, the smart wearable band is used for recreational scuba diving, commercial diving and underwater welding. The band can be water resistant up to a depth of 100 m or more, for up to one hour or more, and can be used to monitor the diver's oxygen levels, heart rate, depth, altitude, and location. The diver can use hand gestures to send audible or visual communications to other divers. The diver can also use hand gestures to operate devices such as cameras, lights, and welding equipment.

In a seventh use case, the smart wearable band is used by military personnel. The band can be used to communicate with, and/or control, drones, weapons, tactical equipment, and communication devices.

In an eight use case, the smart wearable band is used by a driver to communicate and/or control a vehicle. The driver can use gestures and sensors to lock/unlock the vehicle, answer a phone, operate navigation and entertainment equipment, adjust cruise control, activating blinkers, monitor cargo. The smart wearable band can wirelessly communicate with the vehicle's systems.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities, dimensions, properties, and so forth, are used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein, and ranges include their endpoints.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention. Unless a contrary meaning is explicitly stated, all ranges are inclusive of their endpoints, and open-ended ranges are to be interpreted as bounded on the open end by commercially feasible embodiments.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . And N, the text should be interpreted as requiring only one element from the group, not A plus N, or B plus N, etc.

1. A smart wearable band to be worn on a user's hand, comprising:
a first continuous closed loop sized and dimensioned to snugly encircle a base of a thumb of the hand;
a second continuous closed loop sized and dimensioned to encircle a wrist of the hand;
wherein the first loop and second loop are joined at an intersection that is disposed over the thenar webspace on the dorsal side of the hand;
a smart device mounted on or embedded in an outward-facing surface of the intersection between the first loop and the second loop; and
one or more sensors mounted on or embedded in an inward-facing surface of the second loop over a wrist of the hand on the palmar side.

2. The smart wearable band of claim 1, wherein the band is made of a silicone, rubber, or elastomeric polymer that allows the first loop and second loop to stretch and widen.

3. The smart wearable band of claim 2, wherein the band is one unitary part;

4. The smart wearable band of claim 3, wherein the first loop and second loop are formed in the same manufacturing step.

5. The smart wearable band of claim 2, wherein the outward-facing surface of the band is one continuous surface.

6. The smart wearable band of claim 5, wherein the outward-facing surface of the band is smooth.

7. The smart wearable band of claim 1, wherein the first loop comprises a first band having a first thickness and a first height.

8. The smart wearable band of claim 7, wherein the second loop comprises a second band having a second thickness and a second height.

9. The smart wearable band of claim 8, wherein the first band and the second band form an X shape at the intersection.

10. The smart wearable band of claim 1, further comprising a wired connection embedded in the band that electrically couples the sensor to the smart device.

11. The smart wearable band of claim 1, wherein the smart device is removably mounted flush on the outward-facing surface of the intersection.

12. The smart wearable band of claim 1, wherein the one or more sensors is removably mounted flush on the inward-facing surface of the second loop.

13. The smart wearable band of claim 1, wherein the one or more sensors includes a heart rate sensor, and a blood oxygen sensor positioned to directly contact a radial artery pulse point on the palmar side of the wrist.

14. The smart wearable band of claim 1, wherein the one or more sensors is configured to detect omni-directional movement of at least one of a wrist, a thumb, and an index finger.

15. The smart wearable band of claim 1, further comprising a controller programmed to control a remote device based on a movement or gesture of a hand, wrist, or finger detected by the one or more sensors.

16. The smart wearable band of claim 1, wherein the smart devices includes a display.

17. The smart wearable band of claim 1, further comprising a wire embedded in the band that communicatively couples the one or more sensors with the smart device.

18. The smart wearable band of claim 1, wherein the smart device and the one or more sensors are waterproof.

19. The smart wearable band of claim 1, further comprising a controller programmed to map detected hand gestures to control functions for the smart device or a remote device.

20. A smart wearable band to be worn on a user's hand, comprising:
a first continuous closed loop sized and dimensioned to snugly encircle a base of a thumb of the hand;
a second continuous closed loop sized and dimensioned to encircle a wrist of the hand;
wherein the first loop and second loop are joined at an intersection that is disposed over the thenar webspace on the dorsal side of the hand;
a smart device mounted flush on an outward-facing surface of the intersection between the first loop and the second loop; and
one or more sensors mounted on or embedded in the band.
